(19) United States
(12) Patent Application Publication
(10) Pub. No.: US 2005/0178254 A1
(43) Pub. Date: Aug. 18, 2005

(54) Method for setting a location of an incising boundary around one or more objects

(75) Inventor: Adam Jude Ahne, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International Inc.

(21) Appl. No.: 11/103,042

(22) Filed: Apr. 11, 2005

Related U.S. Application Data
(63) Continuation-in-part of application No. 10/612,771, filed on Jul. 2, 2003.

(51) Int. Cl. B41J 11/66

(52) U.S. Cl. 83/13; 400/621

(57) ABSTRACT

A method for setting a location of an incising boundary around at least one object includes determining a perimeter edge of each object around which the incising boundary is to be formed; and assigning a location of the incising boundary in relation to the perimeter edge.

This is a Continuation-In-Part of U.S. patent application Ser. No. 10/612,771, filed Jul. 2, 2003, and entitled, “METHOD FOR FORMING PERFORATIONS IN A SHEET OF MEDIA WITH A PERFORATION SYSTEM.”

### BACKGROUND OF THE INVENTION

1. Field of the Invention

The present invention relates to perforating a sheet of media, and, more particularly, to a method for setting a location of an incising boundary around one or more objects.

2. Description of the Related Art

Various devices are available for performing perforation and/or cutting operations. However, many such devices are used in commercial applications, and are generally cost prohibitive to lower volume users. Also, such devices are often standalone devices, requiring the purchase of additional hardware. While some efforts have been directed to incorporating perforation or cutting devices into an imaging device, there still exists a need for a versatile imaging apparatus and associated method that enables low volume users to enjoy the benefits of perforation. Also, a need exists for a user friendly method for setting a location of an incising boundary around one or more objects.

### SUMMARY OF THE INVENTION

The present invention, in one form thereof, is directed to a method for setting a location of an incising boundary around at least one object. The method includes determining a perimeter edge of each object around which the incising boundary is to be formed; and assigning a location of the incising boundary in relation to the perimeter edge.

The present invention, in another form thereof, is directed to a method for setting a location of an incising boundary around at least one object, including forming a series of stepped outlines around the object; and selecting one outline of the series of stepped outlines for locating the incising boundary.

The present invention, in another form thereof, is directed to a method for setting a location of an incising boundary around an object. The method includes identifying a perimeter of the object; expanding the perimeter outwardly by applying a plurality of successive stepped outlines; determining a perimeter of the outermost outline of the plurality of successive stepped outlines; contracting the perimeter of the outermost outline inwardly by applying a plurality of successive stepped reductions; and locating an incising boundary in relation to an innermost outline formed at the last of the plurality of successive stepped reductions.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of an imaging system employing an embodiment of the present invention.

FIG. 2A shows an end view of an embodiment of the perforator cartridge of the present invention.

FIG. 2B shows a side view of the perforator cartridge of FIG. 2A.

FIG. 2C shows a bottom view of one embodiment of the perforator cartridge of FIG. 2A.

FIG. 2D shows a bottom view of another embodiment of the perforator cartridge of FIG. 2A.

FIG. 3A is a diagrammatic representation of one embodiment of a perforation forming mechanism for the perforation cartridge of FIG. 2A.

FIG. 3B is a diagrammatic representation of another embodiment of a perforation forming mechanism for the perforation cartridge of FIG. 2A.

FIG. 3C is a diagrammatic representation of another embodiment of a perforation forming mechanism for the perforation cartridge of FIG. 2A.

FIG. 4 is a circuit diagram of a control circuit that can be used in the various embodiments of the perforation forming mechanisms of FIGS. 3A-3C.

FIG. 5A is a side diagrammatic view of the mid-frame region of the imaging apparatus of FIG. 1.

FIG. 5B is a side diagrammatic view showing another embodiment of the mid-frame of the imaging apparatus of FIG. 1.

FIG. 6 is a top diagrammatic view showing still another embodiment of the mid-frame of the imaging apparatus of FIG. 1.

FIG. 7 is a diagrammatic representation of an imaging system employing another embodiment of the present invention.

FIG. 8 is a flowchart of a method in accordance with the present invention.

FIG. 9A is an exemplary image used in explaining the invention.

FIG. 9B identifies various exemplary perforation boundaries associated with the image of FIG. 9A.

FIG. 10 is a flowchart of another method in accordance with the present invention.

FIG. 11 is block diagram of a perforation system employing an embodiment of the present invention.

FIG. 12 is a flowchart of still another method in accordance with the present invention.

FIG. 13 is a general flowchart of a method for setting a location of an incising boundary around at least one object, in accordance with another embodiment of the present invention.

FIG. 14 is a further refinement of the step of assigning of a location of an incising boundary of FIG. 13, according to an embodiment of the present invention.

FIG. 15A is a diagrammatic depiction of an object that includes a plurality of coves.

FIG. 15B is a diagrammatic depiction of a perimeter edge of the object of FIG. 15A determined using a snug fit algorithm.

FIG. 15C is a diagrammatic depiction of a series of stepped outlines formed around the perimeter edge of the object shown in FIGS. 15A and 15B.

FIG. 15D is a diagrammatic depiction of an enlarged portion of the series of stepped outlines of FIG. 15C.

FIG. 15E is a diagrammatic depiction of a loose fit incising boundary selected from the series of stepped outlines of FIG. 15C for the object.

FIG. 16 is a flowchart of a further refinement of the step of assigning a location of an incising boundary of FIG. 13, according to another embodiment of the present invention.

FIG. 17A is a diagrammatic depiction of plural small objects to which the principles of the method of FIGS. 13 and 14 may be adapted FIG. 17B is a diagrammatic depiction of the perimeter edges of each object of the plural objects of FIG. 17A.

FIG. 17C is a diagrammatic depiction of a loose fit incising boundary selected from a plurality of stepped outlines formed in accordance with the present invention.

FIGS. 18A and 18B combine to form a flowchart directed to a further refinement of the step of assigning a location of an incising boundary of FIG. 13, according to another embodiment of the present invention.

FIG. 19A is a diagrammatic depiction of an expansion of a perimeter outwardly in stepped increments to form a plurality of stepped outlines.

FIG. 19B is a diagrammatic depiction of a plurality of successive stepped reductions performed to contract, i.e., shrink, the outermost outline of FIG. 19A.

FIG. 19C a diagrammatic depiction of a resulting final outline that is copied back to the object space to surrounding the object of interest, and having a perimeter edge designated as the loose fit incising boundary for the object.

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION OF THE INVENTION

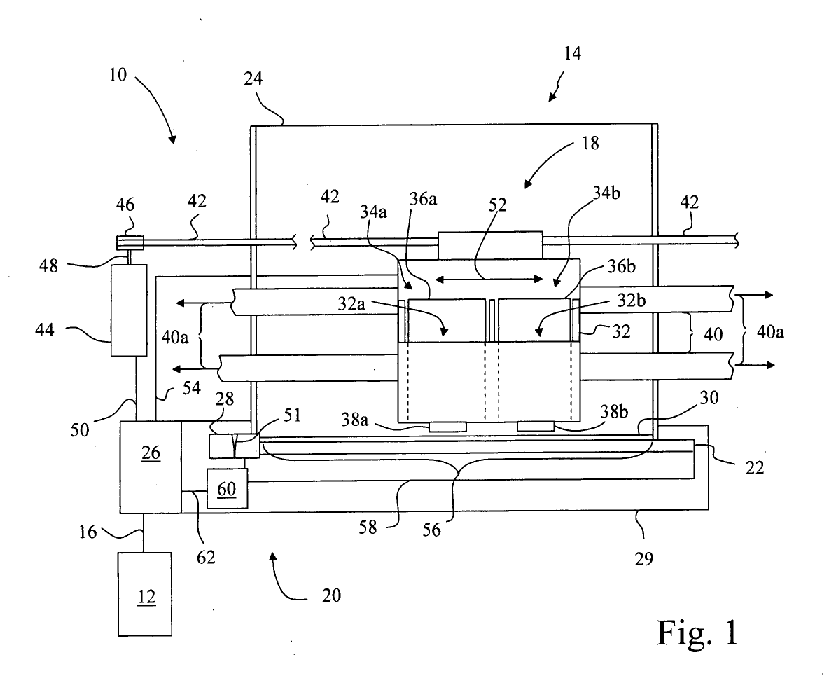

Referring now to the drawings and particularly to FIG. 1, there is shown an imaging system 10 employing an embodiment of the present invention. Imaging system 10 includes a computer 12 and an imaging apparatus in the form of an ink jet printer 14. Computer 12 is communicatively coupled to ink jet printer 14 by way of communications link 16. Communications link 16 may be, for example, a wired connection, an optical connection, such as an optical or r.f. connection, or a network connection, such as an Ethernet Local Area Network.

Computer 12 is typical of that known in the art, and may include a monitor to display graphics or text, an input device such as a keyboard and/or mouse, a microprocessor and associated memory, such as random access memory (RAM), read only memory (ROM) and a mass storage device, such as CD-ROM or DVD hardware. Resident in the memory of computer 12 is printer driver software. The printer driver software places print data and print commands in a format that can be recognized by ink jet printer 14.

Ink jet printer 14 includes a carrier system 18, a feed roller unit 20, a mid-frame 22, a media source 24, a controller 26 and a perforator maintenance station 28. Carrier system 18, feed roller unit 20, mid-frame 22, media source 24, controller 26 and perforator maintenance station 28 are coupled, e.g., mounted, to an imaging apparatus frame 29.

Media source 24 is configured and arranged to supply from a stack of print media a sheet of print media 30 to feed roller unit 20, which in turn further transports the sheet of print media 30 during a printing operation and/or a perforation operation.

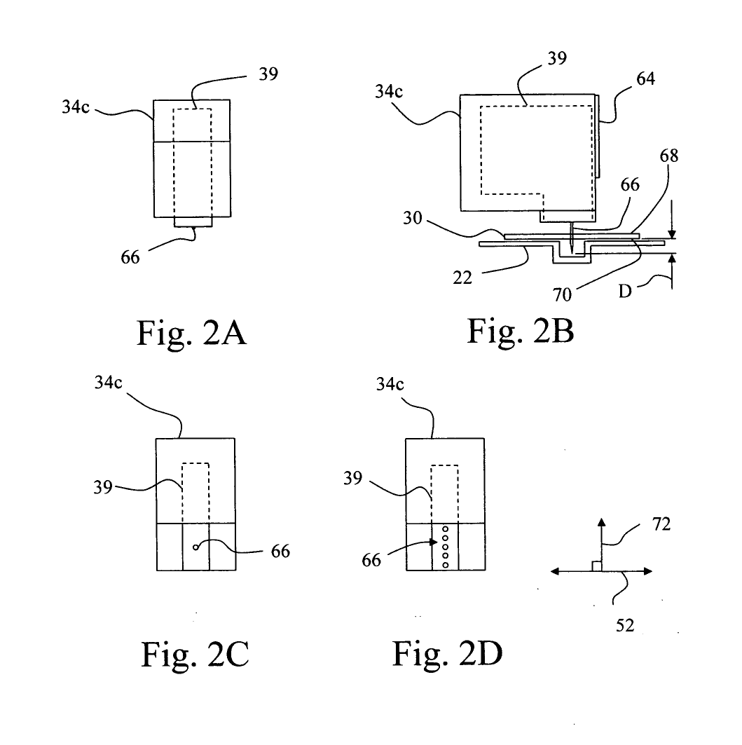

Carrier system 18 includes a carrier 32, i.e., carriage, that is configured with one or more bays, for example bay 32a and bay 32b. Each of bays 32a, 32b is mechanically and electrically configured to mount, carry and facilitate one or more types of cartridges, such as a monochrome printhead cartridge 34a and/or a color printhead cartridge 34b, and/or a perforator cartridge 34c (see FIGS. 2A-2D). Monochrome printhead cartridge 34a includes a monochrome ink reservoir 36a provided in fluid communication with a monochrome ink jet printhead 38a. Color printhead cartridge 34b includes a color ink reservoir 36b provided in fluid communication with a color ink jet printhead 38b. Alternatively, ink reservoirs 36a, 36b may be located off-carrier, and coupled to respective ink jet printheads 38a, 38b via respective fluid conduits. Perforator cartridge 34c is sized and configured to be mechanically and electrically compatible with the configuration of at least one of the printhead cartridges 34a, 34b so as to be interchangeable therewith in carriage 32, and includes a perforation forming mechanism 39.

Carriage 32 is guided by a pair of guide members 40. Either, or both, of guide members 40 may be, for example, a guide rod, or a guide tab formed integral with imaging apparatus frame 29. The axes 40a of guide members 40 define a bi-directional scanning path 52 of carriage 32. Carriage 32 is connected to a carrier transport belt 42 that is driven by a carrier motor 44 via a carrier pulley 46. In this manner, carrier motor 44 is drivably coupled to carriage 32 via carrier transport belt 42, although one skilled in the art will recognize that other drive coupling arrangements could be substituted for the example given, such as for example, a worm gear drive. Carrier motor 44 can be, for example, a direct current motor or a stepper motor. Carrier motor 44 has a rotating motor shaft 48 that is attached to carrier pulley 46. Carrier motor 44 is coupled, e.g., electrically connected, to controller 26 via a communications link 50.

Perforator maintenance station 28 includes an abrasive member 51, such as a ceramic material, arranged to receive and sharpen a perforation device, such as for example, a needle or a blade.

At a directive of controller 26, carriage 32 is transported in a controlled manner along bi-directional scanning path 52, via the rotation of carrier pulley 46 imparted by carrier motor 44. During printing, controller 26 controls the movement of carriage 32 so as to cause carriage 32 to move in a controlled reciprocating manner, back and forth along guide members 40. In order to conduct perforator maintenance operations, e.g., sharpening, controller 26 controls the movement of carriage 32 to position printhead carrier in relation to perforator maintenance station 28. The ink jet printheads 38a, 38b, or alternatively perforation forming mechanism 39, are electrically connected to controller 26 via a communications link 54. Controller 26 supplies electrical address and control signals to ink jet printer 14, and in particular, to the ink jetting actuators of ink jet printheads 38a, 38b, to effect the selective ejection of ink from ink jet printheads 38a, 38b, or to perforation forming mechanism 39 to effect the selective actuation of perforation forming mechanism 39.

During a printing operation, the reciprocation of carriage 32 transports ink jet printheads 38a, 38b across the sheet of print media 30 along bi-directional scanning path 52, i.e., a scanning direction, to define a print zone 56 of ink jet printer 14. Bi-directional scanning path 52, also referred to as scanning direction 52, is parallel with axes 40a of guide members 40, and is also commonly known as the horizontal direction. During each scan of carriage 32, the sheet of print media 30 is held stationary by feed roller unit 20. Feed roller unit 20 includes a feed roller 58 and a drive unit 60. The sheet of print media 30 is transported through print zone 56 by the rotation of feed roller 58 of feed roller unit 20. A rotation of feed roller 58 is effected by drive unit 60. Drive unit 60 is electrically connected to controller 26 via a communications link 62.

FIG. 2A shows an end view of an embodiment of perforator cartridge 34c, including perforation forming mechanism 39. FIG. 2B shows a side view of an embodiment of perforator cartridge 34c, including perforation forming mechanism 39, and shows an electrical interface 64, such as a tape automated bonded (TAB) circuit.

Perforation forming mechanism 39 includes at least one perforation device 66, which may include one or more needles or blades used in forming perforations in the sheet of print media 30. FIG. 2A shows perforation device 66 with a single needle (or blade) exposed, but in a retracted position. FIG. 2B shows perforation device 66 in relation to the sheet of print media 30 having a front side 68 and a back side 70, with back side 70 being supported by mid-frame 22. As shown in FIG. 2B, perforation device 66 has one needle (or blade) exposed, and extending through the sheet of print media 30 by a distance D, as measured from the back side 70 of the sheet of print media 30. Distance D may be, for example, 0.1 millimeters or greater. Depending on the shape of perforation device 66, such as if perforation device is a tapered needle, such as a size 10 hand sewing needle of the quilting betweens type, the distance that perforation device 66 extends through the sheet of print media 30 can effect the size of the perforation opening. Thus, controller 26 may control perforation forming mechanism 39 to drive perforation device 66 at selectable distances D in order to select a particular perforation opening size. Further, by controlling the distance D, perforation forming mechanism 39 can be used to create Braille indicia on the sheet of print media 30, which may be, for example, a transparency sheet or paper. For example, when perforation device 66 is driven through a transparency sheet, a volcano-shaped raised surface is formed on the back side of the transparency sheet.

Referring now to FIGS. 2C and 2D, perforation cartridge 34c can be configured having a single perforation device 66, as depicted in FIG. 2C, or alternatively, may be configured as depicted in FIG. 2D to have multiple perforation devices 66, e.g., multiple needles or blades, arranged, for example, in a column in a print media feed direction 72. Those skilled in the art will recognize that the multiple perforation devices 66 may be arranged in configurations other than a columnar arrangement, such as for example, slanted, staggered, curved, etc.

During a perforation operation, the reciprocation of carriage 32 transports perforator cartridge 34c, including perforation forming mechanism 39, across the sheet of print media 30 along bi-directional scanning path 52, i.e., a scanning direction, to define a perforation zone corresponding to print zone 56 of ink jet printer 14, and for convenience will also be referred to using the element number 56, i.e., perforation zone 56. The sheet of print media 30 is transported in print media feed direction 72 through perforation zone 56 by the rotation of feed roller 58 of feed roller unit 20.

Accordingly, in one embodiment, where perforation forming mechanism 39 has only a single perforation device 66, e.g., a single needle, then the maximum vertical perforation resolution (i.e., in a direction perpendicular to bi-directional scanning path 52, e.g., in print media feed direction 72) is limited to the minimum indexing distance of feed roller 58, while the horizontal perforation resolution (parallel to bi-directional scanning path 52) may be controlled to be as high as the horizontal printing resolution of printheads 38a, 38b, or lower. However, the extent of each perforation formed in the sheet of print media 30 may be increased by using a blade as perforation device 66. As used herein, the term perforation resolution refers to the maximum number of perforation holes in a given distance of the media, such as perforations per inch (ppi).

In another embodiment, where perforation forming mechanism 39 has multiple perforation devices 66, e.g., multiple needles or blades, arranged in a column in the print media feed direction 72, then the maximum vertical perforation resolution and the horizontal perforation resolution may be controlled to be a high as the printing resolution of printheads 38a, 38b, or lower.

Controller 26 is communicatively coupled to perforation forming mechanism 39 via communications link 54 and electrical interface 64 of perforation cartridge 34c. Controller 26 is configured, via hardware, firmware or software, to select either or both of the vertical perforation resolution and the horizontal perforation resolution. Such a selection may be based, for example, on media type (e.g., plain paper, photo paper, stickers, plastic, etc.), media thickness, or a resolution selected by a user. Alternatively, the perforation resolution may be established by computer 12, with perforation resolution commands or data being sent from computer 12 to controller 26.

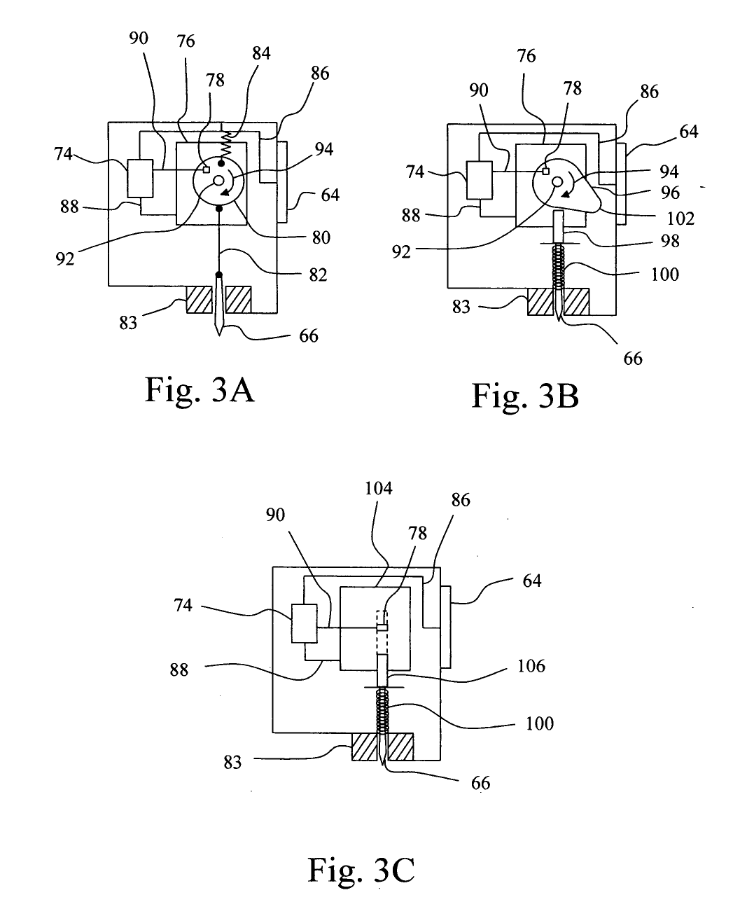

FIGS. 3A, 3B and 3C show three exemplary embodiments of perforation forming mechanism 39, each of which is discussed below.

FIG. 3A shows perforation forming mechanism 39 including, in addition to perforation device 66, a control circuit 74, a motor 76, a sensor 78, a flywheel 80, a linkage 82, a guide bushing 83, and a biasing spring 84. Electrical interface 64 of perforation cartridge 34c is connected to control circuit 74 via a communication link 86, such as for example, a multi-wire cable. Alternatively, electrical interface 64 can be formed on one side of a two layer printed circuit board, and control circuit 74 can be mounted on the opposite side of the printed circuit board. Also, control circuit 74 is connected to motor 76 via a communication link 88, and control circuit 74 is connected to sensor 78 via a communication link 90. Communications links 88 and 90 may be, for example, a multi-wire cable.

Motor 76 includes a shaft 92 connected to flywheel 80. Linkage 82 is pivotably coupled to each of flywheel 80 and perforation device 66. Guide bushing 83 establishes an orientation of perforation device 66, and provides a low friction inner guide surface that contacts perforation device 66. Also, the bottom surface of guide bushing 83 will release perforation device 66 from the sheet of print media 30 as the perforation device 66 is retracted into guide bushing 83, if the sheet of print media 30 become stuck to perforation device 66 during perforation.

A stroke of perforation device 66 may be established based on the location on flywheel 80 where linkage 82 is pivotably attached. As shown, a full rotation of flywheel 80, such as in the clockwise direction 94 as shown, will result in a full cycle of perforation device 66, e.g., from the fully retracted position to the fully extended position, and back to the fully retracted position. Alternatively, a full cycle of perforation device 66 may be performed, for example, by a clockwise half-rotation of flywheel 80 to extend perforation device 66 from the fully retracted position to the fully extended position, followed by a return counter-clockwise half-rotation to return perforation device 66 from the fully extended position to the fully retracted position. As a further alternative, by stopping the rotation of flywheel 80 before perforation device 66 has reached its fully extended position, the distance D that perforation device 66 extends through the sheet of print media 30 (see FIG. 2B) can be selectably controlled. Such control can be effected, for example, by configuring controller 26 to select distance D and control the stroke of perforation device 66 accordingly.

Sensor 78 senses a position of flywheel 80, such as a position indicia or feature representing a home (fully retracted) position. Alternatively, the position indicia, or feature, can be located near the home position, but not at the home position, such that sensor 78 is tripped just before flywheel 80 is at its home position. Also, it is contemplated that multiple position indicia or features may be established around flywheel 80, thereby providing a finer detection of the position of perforation device 66, and in turn, enabling better control over the position of perforation device 66. Such a position indicia or feature may be formed from a material having contrasting characteristics to that of the remainder of flywheel 80. For example, flywheel 80 may have a highly reflective finish except for the position indicia or feature, which has a light absorbing finish. Thus, sensor 78 supplies a signal to control circuit 74 so as to stop rotation of shaft 92 of motor 76, and in turn stop the rotation of flywheel 80, when sensor 78 senses the position indicia or feature on flywheel 80.

Biasing spring 84 is pivotably coupled to flywheel 80, and is located to aid the retention of flywheel 80 in the home position, and in turn, to aid the retention of perforation device 66 in its home (fully retracted) position.

FIG. 3B shows another embodiment of perforation forming mechanism 39, wherein flywheel 80, linkage 82, and biasing spring 84 of FIG. 3A is replaced with a cam 96, a cam follower 98 and a spring 100. Electrical interface 64 of perforation cartridge 34c is connected to control circuit 74 via communication link 86, such as for example, a multi-wire cable. Also, control circuit 74 is connected to motor 76 via communication link 88, and control circuit 74 is connected to sensor 78 via communication link 90.

Shaft 92 of motor 76 connected to cam 96. Cam follower 98 is coupled, e.g., connected to or integral with, perforation device 66. Guide bushing 83 establishes an orientation of perforation device 66, and provides a low friction inner guide surface that contacts perforation device 66. A stroke of perforation device 66 may be established based on the location of a cam lobe 102 on cam 96 in relation to cam follower 98. As shown, a full rotation of cam 96, such as in the clockwise direction 94 as shown, will result in a full cycle of perforation device 66, e.g., from the fully retracted position to the fully extended position, and back to the fully retracted position. Alternatively, a full cycle of perforation device 66 may be performed, for example, by a clockwise half-rotation of cam 96 to extend perforation device 66 from the fully retracted position to the fully extended position, followed by a return counter-clockwise half-rotation that returns perforation device 66 from the fully extended position to the fully retracted position. As a further alternative, by stopping the rotation of cam 96 before perforation device 66 has reached its fully extended position, the distance D that perforation device 66 extends through the sheet of print media 30 can be selectably controlled. Such control can be effected, for example, by configuring controller 26 to select distance D and control the stroke of perforation device 66 accordingly.

Sensor 78 senses a position of cam 96, such as a position indicia or feature representing a home (fully retracted) position. Such a position indicia or feature may be formed from a material having contrasting characteristics to that of the remainder of cam 96. For example, cam 96 may have a highly reflective finish except for the position indicia or feature, which has a light absorbing finish. Thus, sensor 78 supplies a signal to control circuit 74 so as to stop rotation of shaft 92 of motor 76, and in turn stop the rotation of cam 96, when sensor 78 senses the position indicia or feature on cam 96.

Spring 100 is positioned between cam follower 98 and guide bushing 83 to aid in biasing perforation device 66 in its home (fully retracted) position.

FIG. 3C shows another embodiment of perforation forming mechanism 39, wherein the motor 76 and cam follower 98 of FIG. 3B is replaced with a solenoid 104 and an armature 106. Electrical interface 64 of perforation cartridge 34c is connected to control circuit 74 via communication link 86, such as for example, a multi-wire cable. Also, control circuit 74 is connected to solenoid 104 via communication link 88, and control circuit 74 is connected to sensor 78 via communication link 90.

Armature 106 is displaced linearly upon the actuation of solenoid 104. Armature 106 is coupled, e.g., connected to or integral with, perforation device 66. Guide bushing 83 establishes an orientation of perforation device 66, and provides a low friction inner guide surface that contacts perforation device 66. A full cycle of perforation device 66 may be established based on the actuation of solenoid 104 to move perforation device 66 from the fully retracted position to the fully extended position, followed by the de-actuation of solenoid 104 to move perforation device 66 with the biasing aid of spring 100 back to the fully retracted position.

Sensor 78 senses a position of armature 106, such as a position indicia or feature representing a home (fully retracted) position. Such a position indicia or feature may be formed from a material having contrasting characteristics to that of the remainder of armature 106. For example, armature 106 may have a highly reflective finish except for the position indicia or feature, which has a light absorbing finish. Thus, sensor 78 supplies a signal to control circuit 74 to indicate when sensor 78 senses the position indicia or feature on armature 106.

In the various embodiments of FIGS. 3A-3C, sensor 78 will detect when perforation device 66 is not in the fully retracted (home) position, thereby indicating an error condition in the event that perforation device 66 gets stuck in the sheet of print media 30, e.g., remains out of its home position when controller 26 expects perforation device 66 to have returned to the home position.

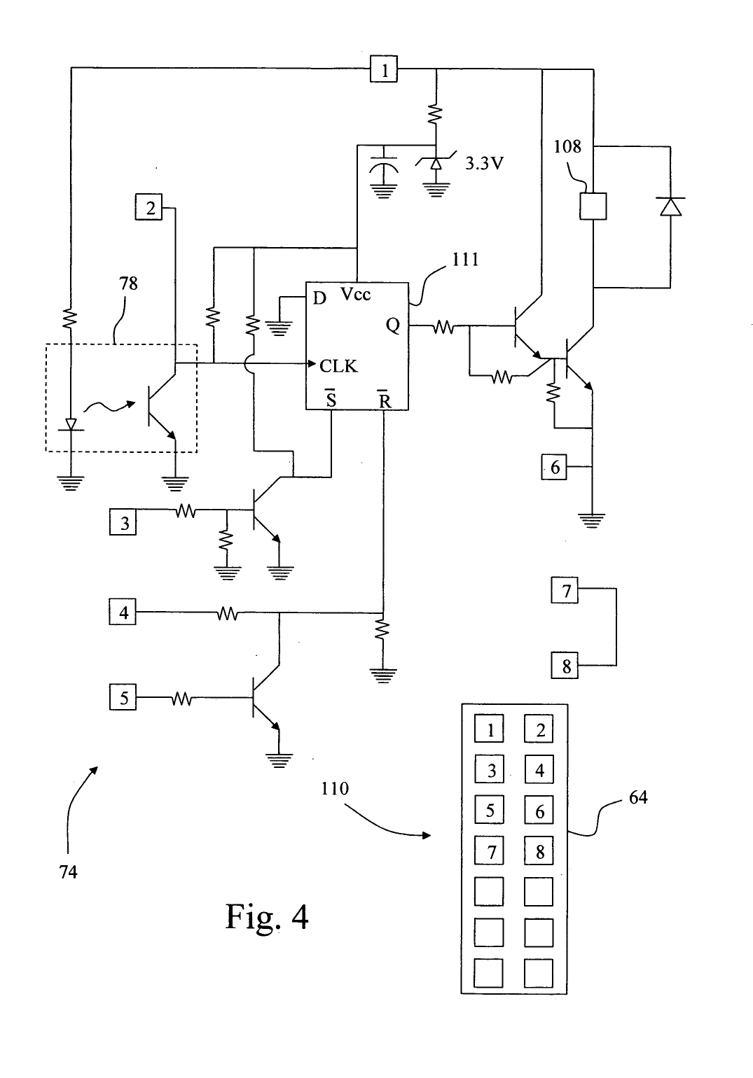

FIG. 4 is an exemplary circuit suitable for use as control circuit 74. Control circuit 74 includes sensor 78, various drive components, and a driven device 108. Driven device 108 represents motor 76 of the embodiments of FIGS. 3A and 3B, and represents solenoid 104 in the embodiment of FIG. 3C. As shown, electrical interface 64 includes a plurality of connection pads 110, with individual connection pads 110-1, 110-2, 110-3, 110-4, 110-5, 110-6, 110-7, and 110-8 being assigned connection points within control circuit 74. In control circuit 74, pads 110-7 and 110-8 are tied together, and in turn are used to indicate to controller 26 that cartridge 34c is in fact a perforation cartridge. Sensor 78 is used to supply a clock input to the D-flip-flop 111. Circuit power is supplied to control circuit 74 via pads 110-1 and 110-2. Controller 26 may set D-flip-flop 111 by supplying a signal to pad 110-3. Controller 26 may reset D-flip-flop 111 by supplying appropriate signals to pads 110-4 and 110-5. Circuit ground may be established, or may be monitored, via pad 110-6. Other aspects of the operation of control circuit 74, as shown in FIG. 4, are readily understood by one skilled in the art, and will not be further discussed herein.

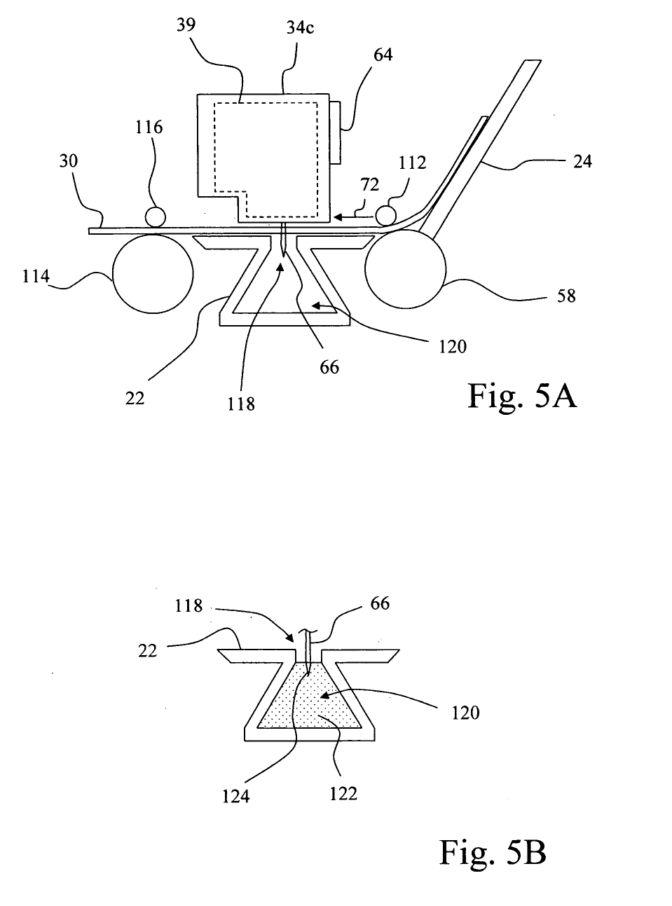

FIG. 5A shows a side diagrammatic view of a portion of printer 14, illustrating a perforation of the sheet of print media 30. As shown, the sheet of print media 30 is transported by feed roller 58 with the aid of its associated pinch roller 112, and by an exit roller 114 with the aid of an associated pinch roller 116. Thus, feed roller 58 is positioned upstream of perforation device 66, in relation to print media feed direction 72. In addition, exit roller 114 is positioned downstream of perforation device 66. As such, in one embodiment the sheet of print media 30 is suspended between feed roller 58 and exit roller 114 during perforation, as shown. Mid-frame 22 provides support for the sheet of print media 30 during perforation. Mid-frame 22 includes a trough 118 that extends along a width of mid-frame 22, e.g., an elongated opening that extends along perforation zone 56, for receiving perforation device 66 as perforation device 66 passes completely through the sheet of print media 30. Mid-frame 22, including trough 118, defines an interior region 120 that may be used for the accumulation of waste paper punch-outs generated during perforation. Trough 118 is configured with a depth such that perforation device 66 does not contact mid-frame 22, i.e., does not contact the bottom of trough 118, when perforation device 66 is at a fully extended position.

Alternatively, as shown in FIG. 5B, interior region 120 may be substantially filled with a foam 122. Foam 122 may be positioned to receive at least a tip portion 124 of perforation device 66, thereby performing a cleaning of perforation device 66 after each perforation. Foam 122 may be, for example, a polyurethane foam or sponge. As a further alternative, interior region 120 may be completely filled with foam to provide support to back side 70 of the sheet of print media 30 at trough 118.

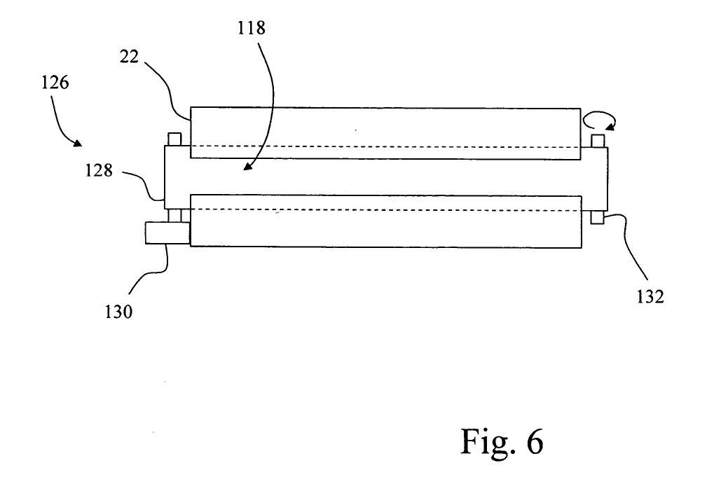

Referring now to FIG. 6, in relation to FIG. 5A, a conveyor unit 126 may be located in trough 118 in interior region 120 of mid-frame 22 to carry away the accumulation of waste paper punch-outs. Conveyer unit 126 includes a conveyor belt 128, a conveyor drive unit 130 and an idler unit 132. Conveyor belt 128 is suspended between conveyor drive unit 130 and an idler unit 132. Conveyor drive unit 130 provides a driving force to advance conveyor belt 128. Conveyor drive unit 130 may be, for example, a ratchet mechanism that increments conveyor belt 128 when conveyor drive unit 130 is engaged by carriage 32. Alternatively, conveyor drive unit 130 may be motor driven.

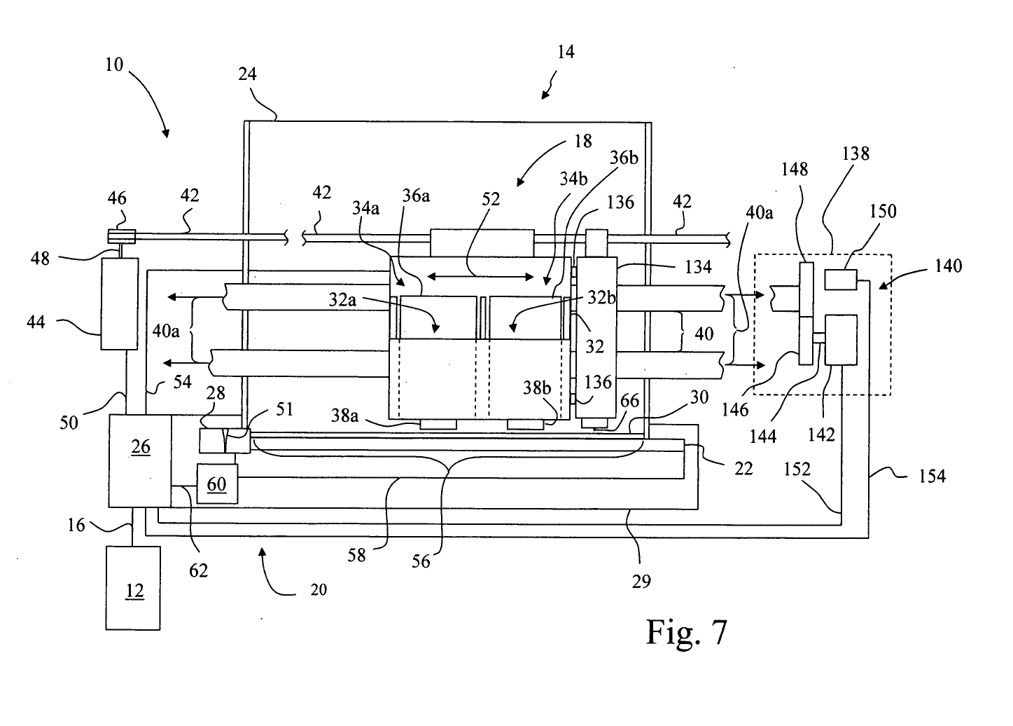

FIG. 7 shows still another embodiment of the invention, which includes a dedicated perforator carriage 134. In this embodiment, carriage 32 may be a dedicated printhead carriage. The various configurations of the invention as shown in FIGS. 5A, 5B and 6, as well as the perforation operating characteristics described above, can also be readily incorporated into the embodiment of FIG. 7. Perforator carriage 134 is connected to carrier transport belt 42, and is coupled to carriage 32 by isolation members 136. Isolation members 136 may be made, for example, of rubber or other material having elastic, vibration absorbing, characteristics. Carrier transport belt 42 may also act as an isolation member. Perforator carriage 134 may be adapted to carry a perforation forming mechanism, such as for example one of the perforations forming mechanisms described above with respect to FIGS. 3A-3C, or another perforation mechanism known in the art. As shown, perforator carriage travels with carriage 32 carrying printheads 38a, 38b in a unitary manner. However, isolation members 136 serve as isolation dampers so that operation of the perforator mechanism in perforator carriage 134 will not transmit mechanical vibrations directly to carriage 32, and in turn to printheads 38a, 38b.

Alternatively, as shown in the breakout section 138, the perforation forming mechanism in perforator carriage 134 may be driven by a perforation drive system 140. Perforation drive system 140 includes a motor 142 having a shaft 144 to which a gear 146 is attached. A second gear 148 is attached to one of the guide members 40. This particular guide member may be a guide rod having a D-shaped cross section, which when rotated emulates the operation of cam 96 of FIG. 3B to drive perforation device 66. Gears 146, 148 are located to be in meshed relation. Also shown is a sensor 150 that is used to detect the home position of D-shaped shaft 40. Motor 142 is electrically connected to controller 26 via a communication link 152. Sensor 150 is electrically connected to controller 26 via communication link 154.

In this embodiment, controller 26 provides perforation commands to motor 142, which responds by rotating D-shaped guide member 40, which drives the perforation forming mechanism in perforator carriage 134, which in turn causes perforation device 66 to extend from its home position to its perforation position. Further rotation of D-shaped guide member 40 results in perforation device 66 returning to its retracted (home) position, wherein sensor 150 provides a signal to controller 26 to turn off motor 142 to stop rotation of D-shaped guide member 40.

The discussion that follows is directed to describing various methods of the invention. Referring to the embodiment of FIG. 1, when perforator cartridge 34c is installed in carriage 32, imaging system 10 is converted into a dual use system, serving both as an imaging system and a perforation system and with imaging apparatus 14 serving as a perforation apparatus. Likewise, referring to the embodiment of FIG. 7, when imaging system 10 is modified to include perforator carriage 134, imaging system 10 is converted into a dual use system, serving both as an imaging system and a perforation system. Accordingly, in the discussions of the various methods of the invention that follow, sometimes for convenience reference will be made to a perforator system 10 to emphasize the perforation functionality of the system. Also, for convenience and ease of understanding, sometimes the methods of the invention will be described with reference to the embodiments of FIGS. 1 and 7. However, it is to be understood that the methods of the invention need not be limited to the embodiments of FIGS. 1 and 7.

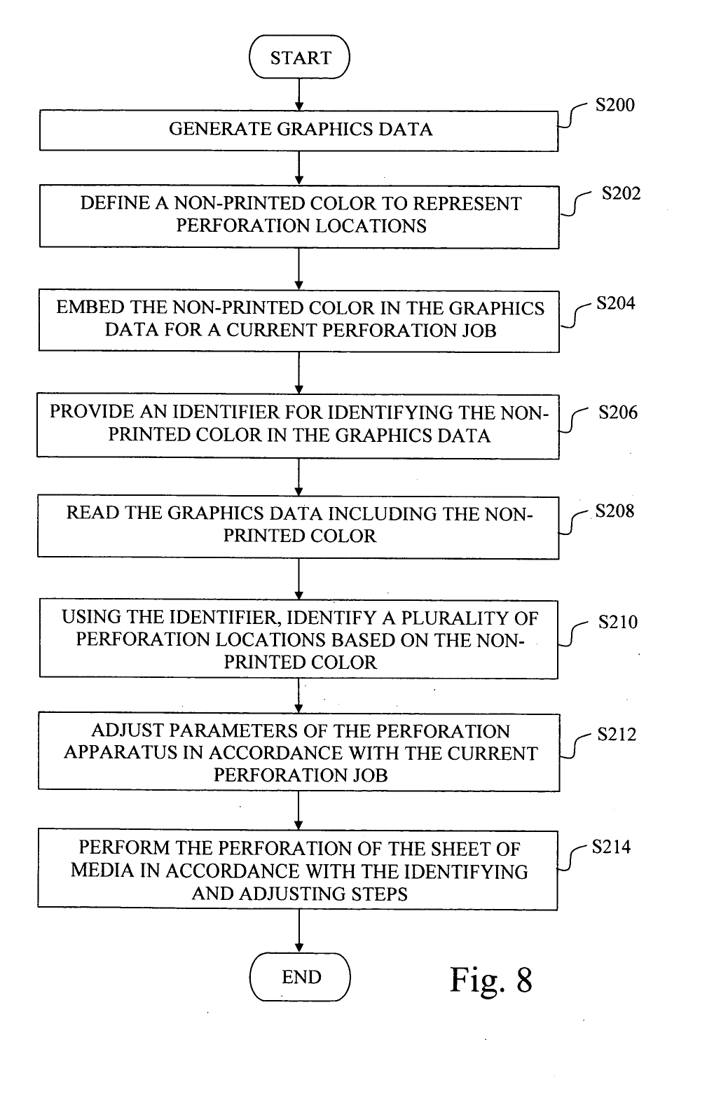

FIG. 8 is directed to a method of forming perforations in sheet of media with a perforation system, such as perforation system 10 that was described above with respect to FIGS. 1-7.

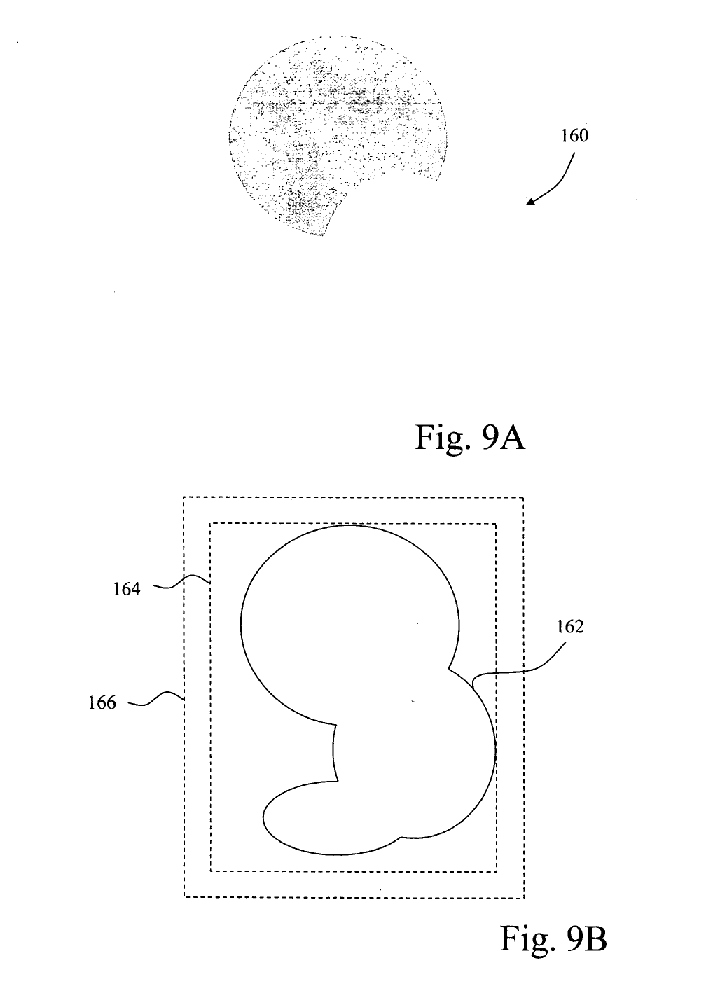

At step S200, graphics data is generated, such as by computer 12 executing a graphics application. Such graphics data may represent, for example, image 160 shown in FIG. 9A.

At step S202, a non-printed color is defined to represent perforation locations.

In one exemplary implementation, the non-printed color may be identifiable by its presence with a predefined sequence of colors. For example, the occurrence of a predefined sequence of two or more colors indicate that the color proceeding, or alternatively following, the predefined sequence is a non-printed color, e.g., the perforation color, which in turn is used to identify perforation locations in the graphics data. For example, the printer driver operating on computer 12, or alternatively imaging apparatus 14, can be programmed to identify the color sequence in the print data and in turn identify the perforation color used to signify a perforation location. Colors may be repeated in the sequence.

As an example, it is predefined that a three pixel color group, beginning with a two color sequence will be followed by the non-printed color, i.e., the perforation color. The three color group may be, for example, a sequence of a yellow pixel and a light gray pixel, followed by a dark gray pixel as the perforation color. When the printer driver operating on computer 12, or alternatively a routine operating in imaging apparatus 14, detects the yellow-light gray sequence of pixels, then the following pixel, e.g., a dark gray pixel, is interpreted and saved, for example in memory associated with computer 12 or controller 26, as a non-printed color to be used as a perforation location identifier. Thereafter, each time the printer driver operating on computer 12, or alternatively imaging apparatus 14, detects a dark gray pixel, the dark gray pixel is identified as a non-printed color and its location by definition is a perforation location which will receive a perforation.

In the present embodiment, the term non-printed color is used to indicate the absence of color at the perforation location after perforation, and thus, not only covers the condition where the perforation location does not receive ink during a printing operation since the perforation will eliminate the material in the sheet of print media 30 at the perforation location, but is intended to also cover the condition wherein the perforation color is first printed, and then removed by the perforation.

In another exemplary implementation, computer 12 may analyze the color data associated with the graphics data, and select a color as the non-printed color that is absent with respect to the graphics data. The non-printed color would still be identified based on the color sequence method described above.

At step S204, the non-printed color is embedded in the graphics data for a current perforation job. Based on boundary information, computer 12, executing a program such as in the printer driver, automatically inserts the predefined color sequence proceeded (or alternatively followed) by the non-printed color, i.e., perforation color, into the graphics data, preferably near the beginning of the graphics data, and then embeds the non-printed color at locations corresponding to the perforation boundary specified by the user.

In one implementation, a boundary detection algorithm may be used to automatically identify the perforation boundary of an image. The boundary detection algorithm may be incorporated, for example, into the printer driver, or may be incorporated into firmware in controller 26. The pseudo code for an exemplary boundary detection algorithm is attached in Appendix A. The pseudo code is in the form of a C++ code snippet that demonstrates how a recursive flood fill algorithm can be used to find the edges of an image. FIG. 9A shows image 160 prior to processing through the boundary algorithm of Appendix A. FIG. 9B shows a boundary 162 of image 160 after processing through the boundary algorithm of Appendix A. As shown, the edges of boundary 162 do not need to be linear, although the edges may be linear. In the example of FIGS. 9A and 9B, image 160 may be, for example, 100 pixels wide by 100 pixels high, and each pixel can be represented by an eight bit value, e.g., an 8 bit paletted bitmap.

If desired, a halo can be drawn around boundary 162 by replacing each edge pixel with a 3×3 block of pixels centered on the original pixel, and then processing the resulting image with the boundary detection algorithm of Appendix A.

Those skilled in the art will recognize that in practicing the present invention other edge detection algorithms well known in the art could be adapted for substitution for the boundary algorithm represented in Appendix A.

In the present implementation, once boundary 162 of image 160 is identified from the graphics data, a plurality of perforation locations may be assigned to the boundary, at a predetermined default perforation resolution, such as for example 100 ppi, which may later be adjusted.

Alternatively, a polygonal perforation perimeter may be defined to surround boundary 162, at a predetermined perforation resolution, wherein a plurality of perforation locations may be assigned to the polygonal perforation perimeter. For example, a polygonal perforation perimeter 164, such as a rectangle, may be defined to intersects boundary 162 of image 160 represented in the graphics data at least at one perforation location of the plurality of perforation locations. As another example, the plurality of perforation locations are associated with a polygonal perforation perimeter 166, such as a rectangle, that surrounds boundary 162 of image 160, but does not intersect boundary 162 of image 160.

For example, a rectangular perforation perimeter may be determined by electronically scanning the data representing image 160 (FIG. 9A), or image boundary 162 (FIG. 9B) and recording the Cartesian coordinates (e.g., x,y coordinates) of the highest, lowest, leftmost, and rightmost edge pixel points. Accordingly, one of rectangular perforation perimeters 164 or 166 may be positioned to define a rectangle perforation boundary defining a plurality of perforation locations based on the four pixel points. In one implementation, for example, rectangular perforation perimeter 164 can be sized to intersect all four pixel points.

In another implementation, the embedding may be performed, for example, by perforation software running on computer 12, wherein a user selects a perforation boundary around the image to receive perforations. Such a perforation boundary might be entered, for example, by tracing a light pen around image 160 as presented on the monitor of computer 12, or by entering data points from a keyboard.

Further, as an alternative in the above implementations, it is contemplated that perforation coordinates could be supplied to imaging apparatus 14 via a data packet that accompanies each print job sent to imaging apparatus 14.

At step S206, an identifier is provided for identifying the non-printed color in the graphics data. In particular, at step S206, as mentioned above, software operating on computer 12, such as in the printer driver, automatically embeds the identifier as a predefined color sequence proceeded (or alternatively followed) by the non-printed color, i.e., perforation color, into the graphics data, preferably near the beginning of the graphics data to identity to the graphics data reader which color of a plurality of possible colors serves as the non-printed color, i.e., the perforation color for this perforation job.

At step S208, the graphics data, including the non-printed color, is read, for example, by imaging (perforation) apparatus 14.

At step S210, using the identifier, a plurality of perforation locations are identified by apparatus 14 based on the non-printed color.

At step S212, parameters of the perforation apparatus 14 are adjusted in accordance with the current perforation job.

In one implementation of the invention, the adjusting step may include the step of adjusting a perforation density, e.g., perforations per inch (ppi) of the plurality of perforation locations. The perforation density may be dependent on at least one of a print mode, e.g. draft, normal, etc., a media type and a media thickness of the sheet of print media 30. In addition, by setting the perforation density to a value wherein the perforations, i.e., holes, overlap, then a cut is made.

For example, a plain paper sheet may require less perforation per unit length than a photo paper sheet in order to achieve and acceptable punch-out of the perforated item from the surrounding scrap. Accordingly, for example, plain paper may be perforated at 30 ppi, whereas a photo paper sheet may be perforated at 40 ppi.

As another example, a thin media may require less perforation per unit length than a thick media in order to achieve and acceptable punch-out of the perforated item from the surrounding scrap. Accordingly, for example, thin paper may be perforated at 20 ppi, whereas as poster board may be perforated at 45 ppi.

In another implementation of the invention, the adjusting step may include the step of adjusting a perforation speed of forming the perforations at the plurality of perforation locations. The perforation speed may be adjusted, for example, based on factors such as media type, media thickness, and perforation resolution.

In another implementation of the invention, the adjusting step may include the step of adjusting a perforation force of perforation device 66 that forms the perforations. The perforation force may be determined, for example, by monitoring a motor torque of a motor, e.g., motor 44 of FIG. 1 or motor 142 of FIG. 7, that drives the respective perforation device 66, including tip portion 124 for puncturing the sheet of media 30 to form the perforations.

The motor torque is related to the current drawn by motor 44, 142. Thus, by monitoring the motor current, such as through a simple voltage divider circuit well known in the art, the motor current can be determined, and in turn, the perforation force. Accordingly, the perforation force may then be adjusted automatically to a desired force by adjusting the motor torque. As an example, the perforation force adjustment operation may be performed during a perforation of the sheet of print media sheet at a first perforation location occurrence of the plurality of perforation locations, so that subsequent perforations are formed with the proper perforation force. The motor torque can also be used in setting the perforation density and perforation speed.

At step S214, the perforation of the sheet of media 30 is performed in accordance with the identifying and adjusting steps, set forth above. The actual perforation may be carried out by perforation system 10, as embodied in one of FIGS. 1 and 7, or alternatively, by some other perforation mechanism known in the art that is reconfigured to operate in accordance with the method of FIG. 8 of the present invention. Along with performing the perforation, the graphics data is printed as an image on the sheet of media 30.

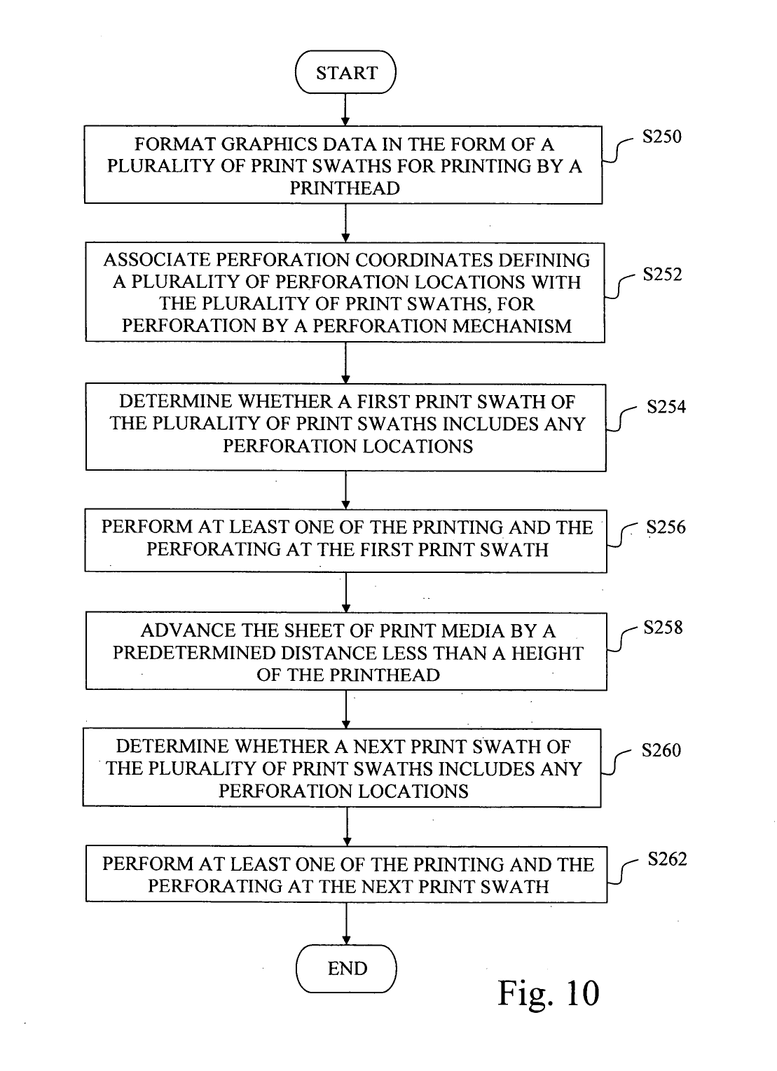

Such combined printing and perforating can be performed sequentially, or can be performed simultaneously, in a given printing swath with system 10 in either of the embodiments of FIGS. 1 and 7. FIG. 10 is a flowchart of an exemplary method for carrying out combined printing and perforating.

The method of FIG. 10 may be carried out in system 10 in either of the embodiments of FIGS. 1 and 7. However, for convenience and ease of understanding, the method of FIG. 10 will be described below with respect to only FIG. 1. It is to be understood, however, that the method of FIG. 10 may be used with the embodiment of FIG. 7 as well.

Imaging apparatus 14 includes carrier system 18 configured to carry a printhead, such as for example, either or both of monochrome printhead 38a and color printhead 38b, and is configured to carry a perforation forming mechanism, such as perforation forming mechanism 39. In the example that follows, for simplicity, reference will only be made to color printhead 38b. During printing, printhead 38b is traced over the sheet of print media 30, wherein the area traced by the printhead defines a print swath having a swath height equal to the spacing between the uppermost and lowermost ink jetting nozzles in printhead 38b. Typically, the sheet of print media is incrementally advanced by feed roller 58 prior to printhead 38b tracing the next print swath. Such concepts are well known in the art. A control unit, which may include the printer driver operating on computer 12 and controller 26 of imaging apparatus, is coupled to printhead 38b and to perforation forming mechanism 39.

The control unit is configured to perform the steps set forth in FIG. 10, as follows.

At step S250, graphics data is formatted into a plurality of print swaths for printing by printhead 38b.

At step S252, perforation coordinates defining a plurality of perforation locations are associated with the plurality of print swaths, for perforation by perforation forming mechanism 39.

At step S254, it is determined whether a first print swath of the plurality of print swaths includes any perforation locations.

At step S256, at least one of the printing and perforating operations are performed at the first print swath.

At step S258, the sheet of print media 30 is incrementally advanced by feed roller 58 by a predetermined distance less than a height of printhead 38b.

At step S260, it is determined whether a next print swath of the plurality of print swaths includes any perforation locations.

At step S262, at least one of the printing and the perforating are performed at the next print swath.

The control unit is further configured to repeat the steps S258, S260 and S262 until the sheet of print media 30 is completely processed.

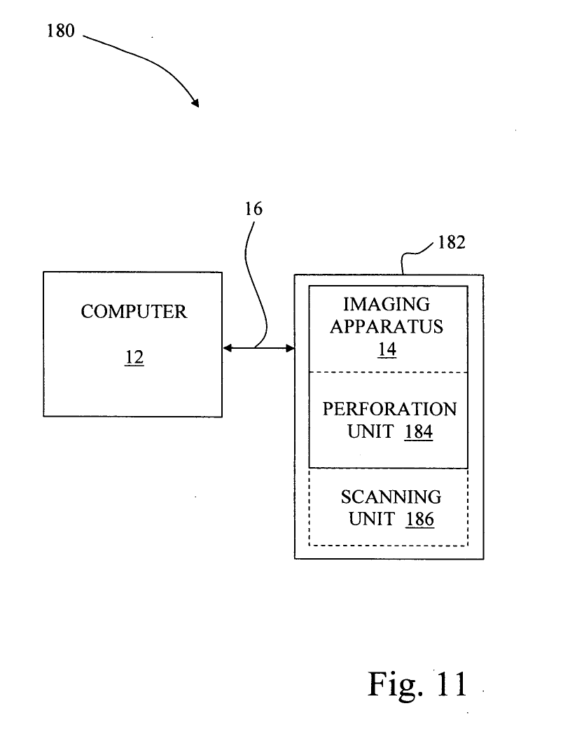

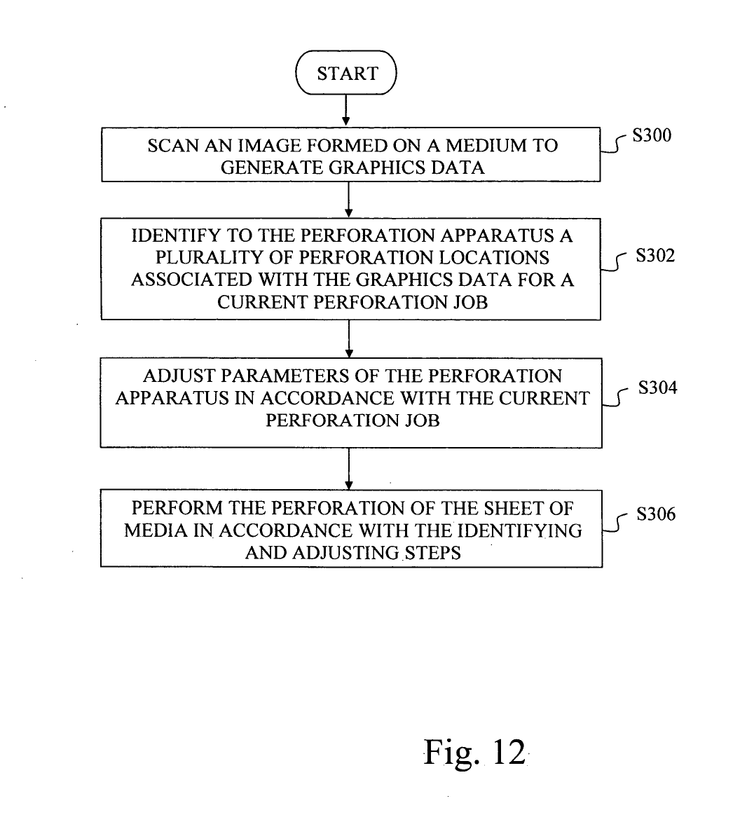

FIG. 11 shows another embodiment of the invention. A perforation system 180 includes computer 12 and a perforation apparatus 182. Apparatus 182 includes imaging apparatus 14, a perforation unit 184, and a scanning unit 186. Computer 12 is communicatively coupled to perforation apparatus 182 via communications link 16. Perforation unit 184 may be, for example, the perforation cartridge 34c as described above with reference to FIG. 1, or may be the perforator carriage 134 and its associated mechanisms, as described above with respect to FIG. 7. Scanner unit 186 may be, for example, a commercially available stand alone scanner, or a similar scanning unit physically incorporated into imaging apparatus 14. Perforation system 180 may be operated, for example, in accordance with the method described below with respect to FIG. 12.

The method for forming perforations in a sheet of media, as illustrated in the flowchart of FIG. 12, will be described below in conjunction with FIGS. 9A, 9B and 11.

At step S300, an image, such as image 160 of FIG. 9A that is formed on a medium, such as the sheet of print media 30, is scanned by scanning unit 186 to generate graphics data.

At step S302, a plurality of perforation locations associated with the graphics data is identified to perforation apparatus 182 for a current perforation job. Step S302 may be performed, for example, by utilizing the method steps S202, S204, S206, S208 and S210 of FIG. 8. Alternatively, methods known in the art for identifying perforation locations to a perforation apparatus could be adapted for performing step S302.

At step S304, parameters of perforation apparatus 182 are adjusted in accordance with the current perforation job. The parameter adjustment of step S304 may be performed, for example, in a manner as described above in step S212 of FIG. 8.

At step S306, perforation of the sheet of media 30 is performed in accordance with identifying step S302 and adjusting step S304. Along with performing the perforation, the graphics data may be printed as an image on the sheet of media 30. Such combined printing and perforating can be performed sequentially, or can be performed simultaneously, in a given printing swath with system 10 in either of the embodiments of FIGS. 1 and 7. Step S306 may be performed, for example, in a manner as described above in step S214 of FIG. 8.

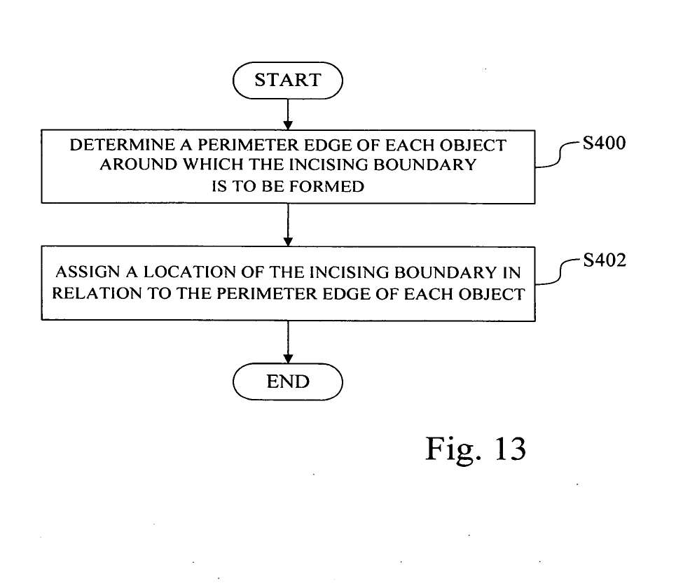

FIG. 13 is a general flowchart of a method for setting a location of an incising boundary around at least one object, in accordance with another embodiment of the present invention.

At step S400, a perimeter edge of each object is determined around which the incising boundary is to be formed. This determination may be performed, for example, by a snug fit algorithm, such as for example, the algorithm described above with respect to FIG. 8 and Appendix A.

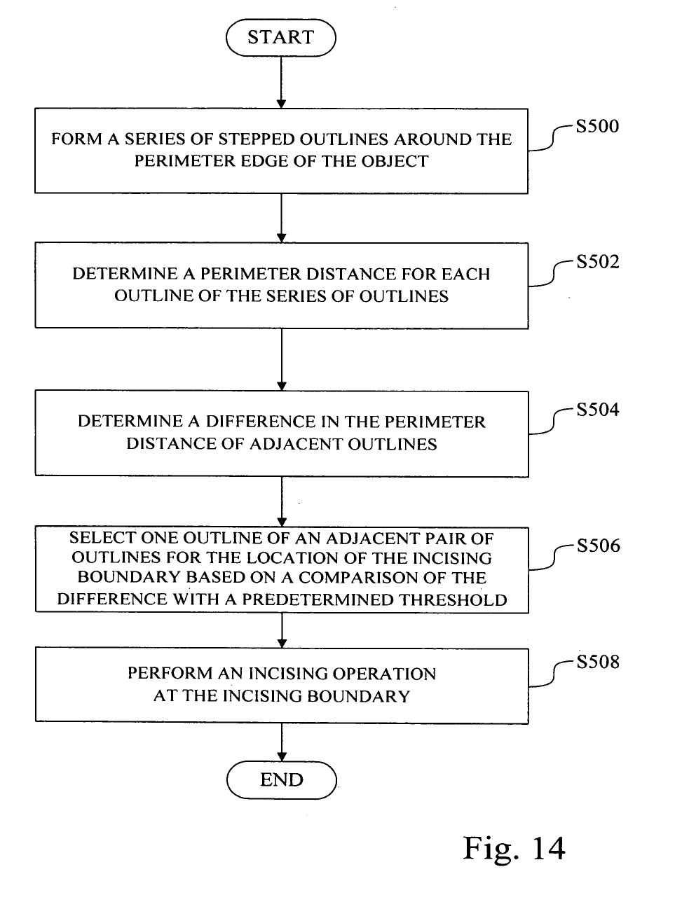

At step S402, a location of the incising boundary is assigned in relation to the perimeter edge of each object. FIGS. 14, 16 and 18A, 18B each include a flowchart describing respective embodiments including method steps further defining step S402 of FIG. 13.

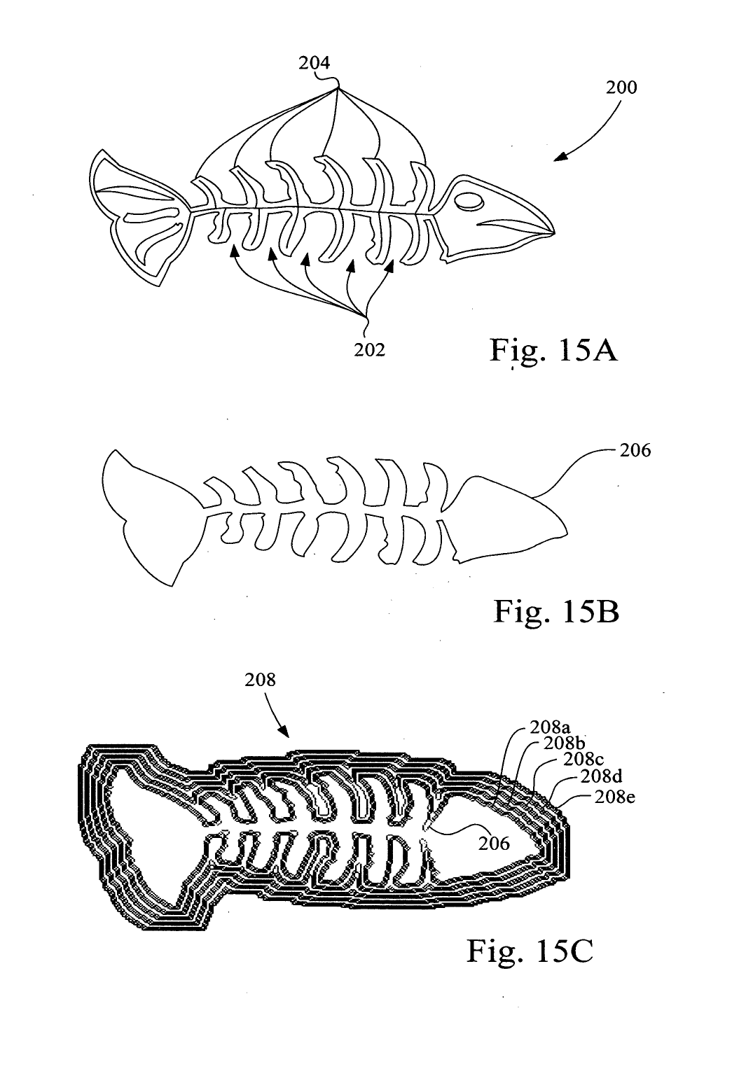

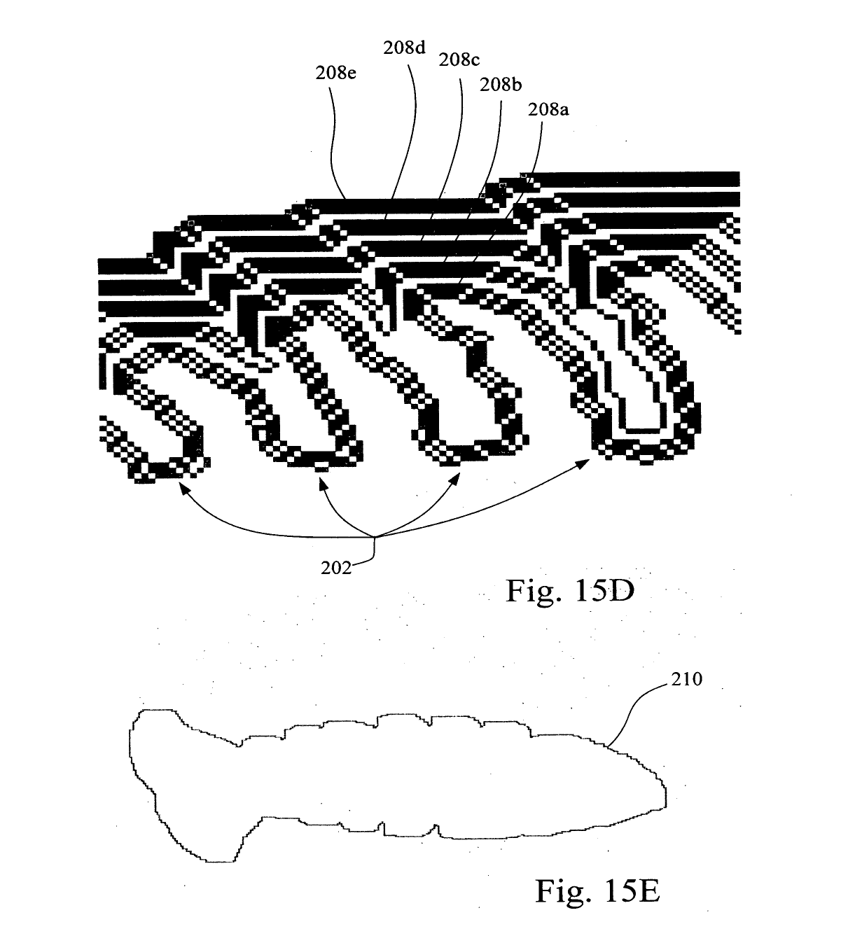

FIG. 14 is a further refinement of step S402 for assigning an incising boundary, in accordance with one embodiment of the present invention, to provide a loose fit of the incising boundary around the object or objects around which the incising boundary is to be formed. The method of FIG. 14 will be described below with respect to the exemplary graphics of FIGS. 15A, 15B, 15C, 15D, and 15E.

FIG. 15A shows an object 200 that includes a plurality of coves 202. As shown, the elongated features 204 between the coves are relatively narrow. FIG. 15B shows a perimeter edge 206 of object 200 determined using a snug fit algorithm in accordance with step S402 described above. If at this point perimeter edge 206 was selected as the incising boundary, it is highly possible that one or more of the elongated features 204 of object 200 will be damaged by a manual punching out of object 200 following an incising, e.g., perforation, operation.

Referring to FIG. 14 at step S500, and with further reference to FIGS. 15C and 15D, a series of stepped outlines 208, individually identified as stepped outlines 208a, 208b, 208c, 208d and 208e, are formed around the perimeter edge 206 of object 200. The formation of each of the series of outlines 208 may be achieved, for example, by successive applications of a snug fit algorithm, such as for example, the algorithm described above with respect to FIG. 8 and Appendix A, around the previous outline. Each outline is expanded to have a predetermined thickness, such as for example, by 8 adjacent pixels, and the pixels are marked as belonging to the particular outline.

The series of stepped outlines 208 may be a predetermined number of stepped outlines, and may be, for example, one, two, three, or more outlines. In the example of FIG. 15C, five outlines 208a, 208b, 208c, 208d and 208e are formed, with each successively surrounding a prior perimeter pattern.

At step S502, a perimeter distance is determined for each outline 208a, 208b, 208c, 208d and 208e of the series of outlines 208. The perimeter distance may be measured, for example, in units of perforations per inch (PPI), and may be performed, for example, by measuring the perimeter distance of a particular outline prior to the expansion to the predetermined thickness. The perimeter distance, e.g., the circumference, may be determined by counting the number of perforation locations associated with the particular outline under consideration.

At step S504, a difference AD in the perimeter distance of adjacent outlines is determined for each pair of outlines. In the example of FIGS. 15C and 15D, the adjacent outlines that form pairs of stepped outlines are: 208a, 208b; 208b, 208c; 208c, 208d; and, 208d, 208e. Each of the differences ΔD may be determined by a simple mathematical calculation.

At step S506, one outline of an adjacent pair of outlines is selected for the location of the incising boundary 210 (see FIG. 15E) based on a comparison of the difference ΔD for each pair of adjacent outlines with a predetermined threshold. The selecting may begin, for example, at an outermost outline 208e and progress inward toward the perimeter edge 206 of object 200. The predetermined threshold may be, for example, in units of perforations per inch PPI, and the predetermined threshold may be, for example, approximately the desired PPI divided by 2. As an example, if the perforation density is 75 PPI, then the predetermined threshold may be a value, for example, in a range of 35-39 PPI.

In an embodiment using perforation, perforation locations at the desired perforation density are assigned to the incising boundary 210. If a punch out item is desired, the perforation density may be, for example, about 75 PPI. If a cutout is desired, the perforation density may be, for example, about 150 PPI.

If none of the differences AD in the perimeter distance of adjacent outlines is greater than the predetermined threshold, e.g., PPI divided by 2, then the perimeter edge of the object(s) is selected as the incising boundary, but this is not the case with the example of FIGS. 15A-15E.

At step S508, an incising operation, such as perforation or cutting, is performed at incising boundary 210.

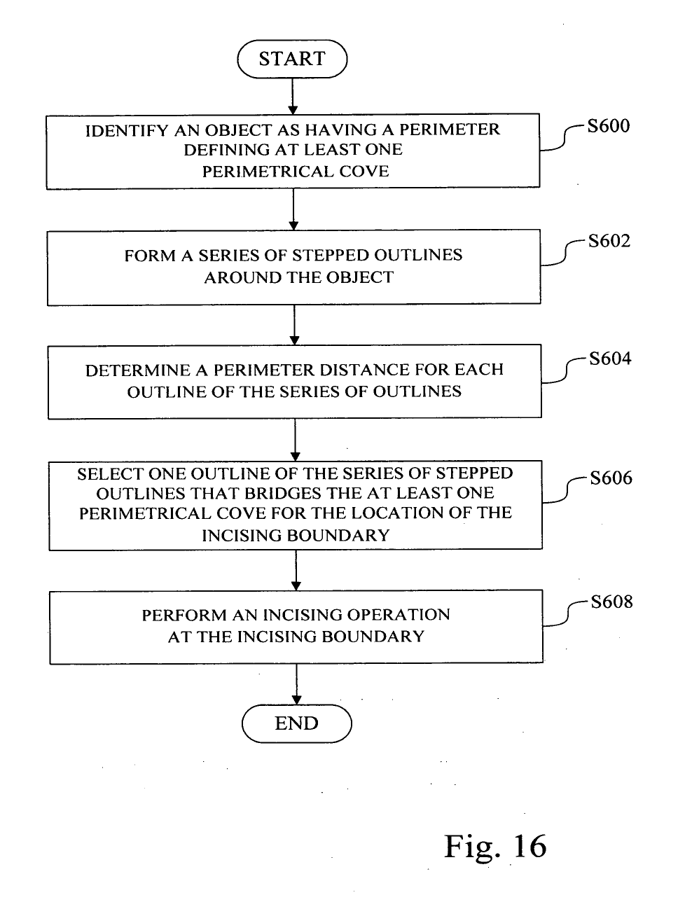

FIG. 16 is a further refinement of step S402 of FIG. 13, in accordance with another embodiment of the present invention to provide a loose fit of the incising boundary around the object or objects around which the incising boundary is to be formed.

At step S600, object 200 is identified as an object as having a perimeter defining at least one perimetrical cove, e.g., the plurality of coves 202.

At step S602, a series of stepped outlines 208 are formed around object 200. The formation of each outline 208a-208e of the series of outlines 208 may be formed, for example, by successive applications of a snug fit algorithm, such as for example, the algorithm described above with respect to FIG. 8 and Appendix A, around the previous outline. Each outline is expanded to have a predetermined thickness, such as for example, by 8 adjacent pixels, and the pixels are marked as belonging to the particular outline.

At step S604, a perimeter distance for each of the series of outlines is determined. The perimeter distance may be measured, for example, in units of perforations per inch (PPI).

At step S606, one outline of the series of stepped outlines that bridges the plurality of coves 202 is selected for the location of the incising boundary.

As shown in more detail in FIG. 15D, and with further reference to FIGS. 15B and 15C, stepped outline 208a retains essentially all of the perimeter detail of the plurality of coves 202. Stepped outline 208b retains some of the cove aspects of the plurality of coves 202. Stepped outline 208c bridges most of the coves, while the rightmost cove shown in FIG. 15D is not totally bridged over. The terms “bridges” and “bridged over” means that the outline does not abruptly dip by more than about 20 percent of the depth of the cove of the object in a region of the outline corresponding to the cove, but rather generally smoothly crosses over the region corresponding to the cove of the object. For example, in some embodiments, the amount of dip will be in a range of 0.0 percent to 5 percent. After the fourth successive application of the snug fit algorithm, outline 208d, as well as outline 208e, bridges over all of the plurality of coves 202 of object 200.

In the present embodiment, the selecting begins at an innermost outline 208a with respect to the perimeter edge 206 of the object 200 and progresses outward toward the outermost outline 208e. The selecting may include, for example, identifying an outline from the series of stepped outlines that has a smaller perimeter distance than the perimeter distance of a previous outline. More particularly, a difference in the perimeter distance of adjacent outlines, e.g.: 208a, 208b; 208b, 208c; 208c, 208d; and, 208d, 208e, may be determined, and an outline may be identified that has a smaller perimeter distance than the perimeter distance of a previous outline.

As a further refinement, the outline selected may be the last outline wherein the perimeter difference is greater than a predetermined threshold. The predetermined threshold may be, for example, in units of perforations per inch PPI, and the predetermined threshold may be, for example, about the PPI divided by 2. Based on the above, stepped outline 208c is selected as the loose fit incising boundary 210 for this embodiment.

At step S608, an incising operation, such as perforation or cutting, is performed at incising boundary 210.

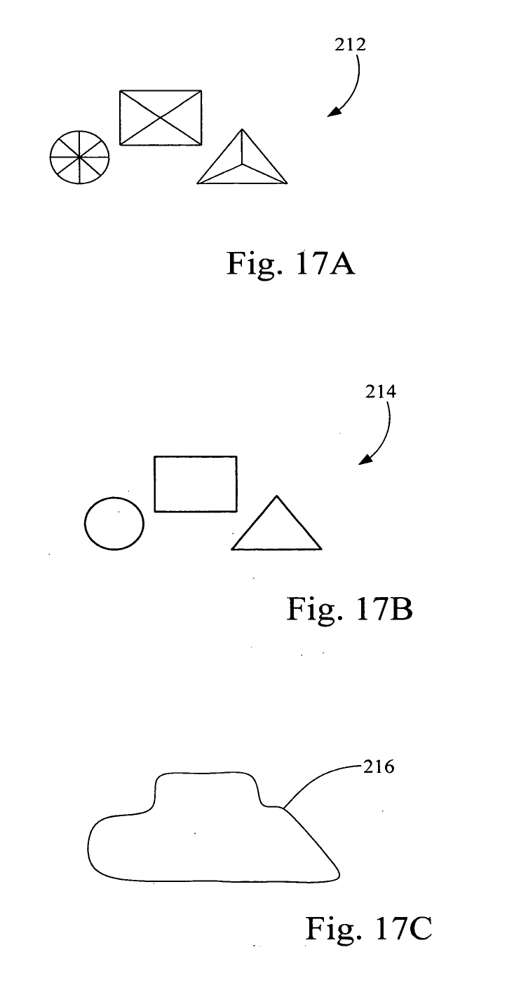

Referring to FIG. 17A, the above methods, such as the method of FIGS. 13 and 14, also may be adapted to accommodate plural small objects 212. As shown in FIG. 17B, the perimeter edge 214 of each object of the plural objects 212 is first determined by application of a snug fit algorithm. Then, after successive applications of the stepped outlines described above, the perimeters merge to form a single boundary. The loose fit incising boundary 216 shown in FIG. 17C is selected when all individual outlines around each of said plurality of objects merge into a single outline as a result of the successive application of the stepped outlines and snug fit algorithm described above. In this case the perimeters of all the objects are combined before the perimeter distance is computed.

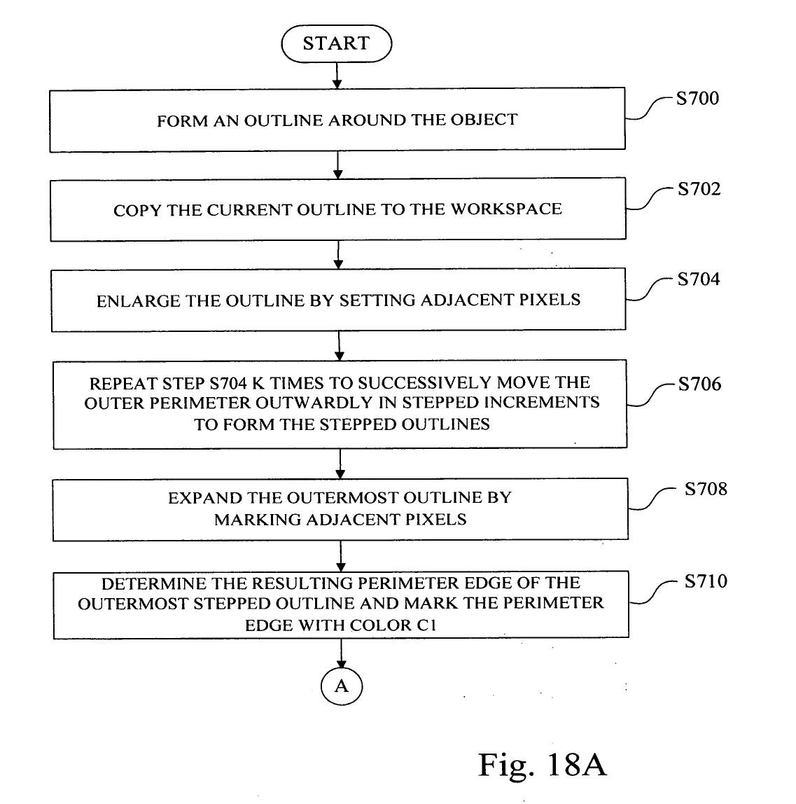

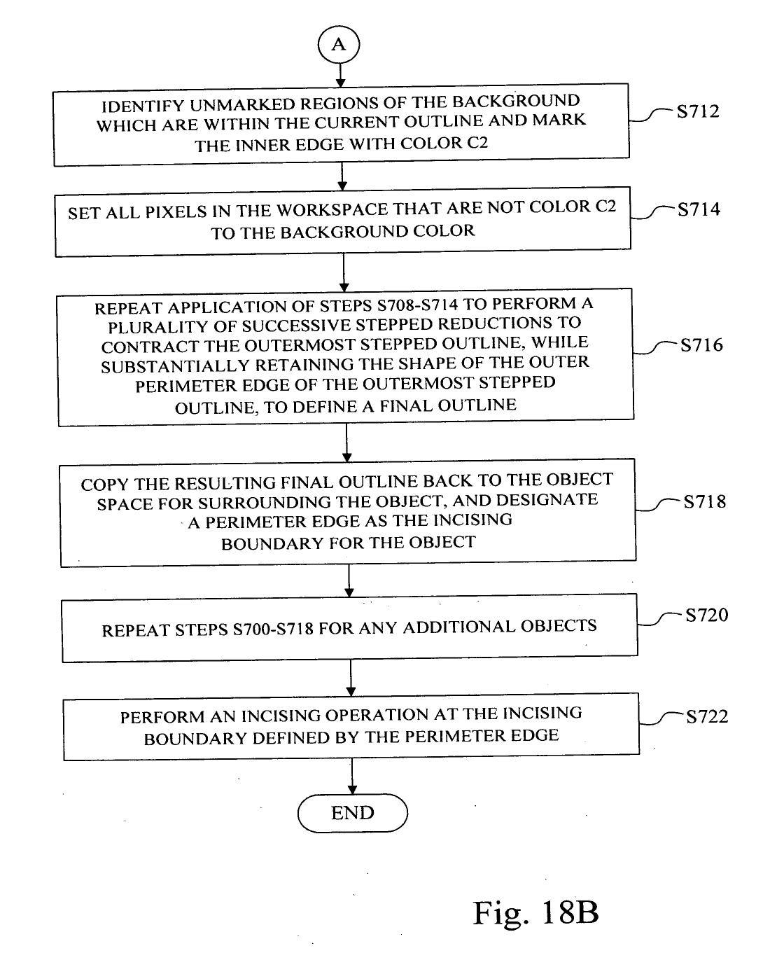

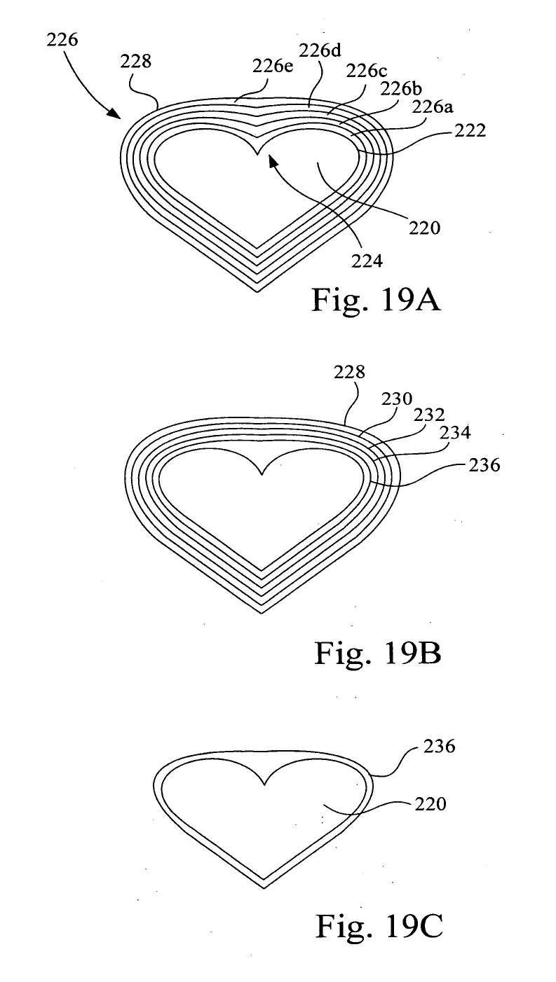

FIGS. 18A and 18B combine to form a flowchart directed to a further refinement of step S402, in accordance with still another embodiment of the present invention, to provide a loose fit of the incising boundary around the object or objects around which the incising boundary is to be formed. The method will be described with further reference to FIGS. 19A-19C, and the method is useful in handling one or more objects, such as object 220, that includes at least one perimetrical cove. In this example, object 220 is in the form of a heart having a perimeter 222 including a perimetrical cove 224.

Preliminary to performing the method of the present invention, a workspace, such as a two dimensional workspace, is created that is large enough to hold the largest object plus two times K pixels, wherein K is a constant, in each dimension. The workspace may be formed, for example, in memory associated with controller 26.

At step S700, an outline 226a is formed around object 220. Outline 226a may be formed, for example, by application of a snug fit algorithm, such as for example, the algorithm described above. Each outline will be marked by a separate color which is distinguishable from the background.

To perform the marking, start by finding a pixel that is not the background color, and recursively mark the pixel and all adjacent non-background pixels to the new color. Then, check every pixel in the outline image to see if it is the background color, a non-marked pixel, or a marked pixel.

At step S702, the current outline, e.g., stepped outline 226a, is copied to the workspace, and may be deleted from the object space of object 220. The outline may be found by looking for pixels having the color assigned to the outline.

At step S704, stepped outline 226a is enlarged by setting adjacent pixels. For example, each outline may have a predetermined thickness, such as for example, 8 adjacent pixels, and the pixels are marked as belonging to the particular outline. The outer perimeter of outline 226a is determined, such as by using the snug fit algorithm, e.g., the algorithm described above with respect to FIG. 8 and Appendix A.

At step S706, step S704 is repeated K times to successively move the outer perimeter outwardly, i.e., to expand the outer perimeter, in stepped increments to form the stepped outlines 226, individually identified as stepped outlines 226a-226e shown in FIG. 19A. The constant K may be a desired value, and may be related to the selected perforation density. For example, where the perforation density is selected to be 75 PPI, then K may be equal to 18. For illustrative purposes, however, a value of K=5 is used, resulting in the five stepped outlines 226a-226e of FIG. 19A.

At step S708, the outline 226e is expanded by marking adjacent pixels.

At step S710, the resulting perimeter edge 228 of outermost stepped outline 226e is determined, such as by using the snug fit algorithm, e.g., the algorithm described above with respect to FIG. 8 and Appendix A. Perimeter edge 228 is marked using a color C1.

At step S712, unmarked regions of the background are identified, which are within the current outline, e.g., outline 226e, and the inner edge of outline 226e is marked with color C2 by applying the snug fit algorithm on the inside of the outline, i.e., in the identified unmarked regions.

At step S714, all pixels in the workspace that are not color C2 are set to the background color.

At step S716, referring to FIG. 19B, through repeated application of steps S708-S714, a plurality of successive stepped reductions are performed to contract, i.e., shrink, outline 226e, successively forming new perimeter edges 230, 232, 234, and 236, while substantially retaining the shape of perimeter edge 228 of outermost stepped outline 226e, to define a final outline corresponding to perimeter edge 236.

At step S718, the resulting final outline is copied back to the object space for surrounding object 220, as shown in FIG. 19C, and perimeter edge 236 is designated as the incising boundary for object 220.

At step S720, steps S700-S718 are repeated for any additional objects.

At step S722, an incising operation, such as perforation or cutting, is performed at the incising boundary defined by perimeter edge 236.

Those skilled in the art will recognize that the above described contracting steps, e.g., the repeated application of steps S708-S714, may be applied to the other loose fit methods wherein stepped outlines are used to expand the outline perimeter, so as to reduce the amount of extra material surrounding the object(s) of interest.

While this invention has been described with respect to embodiments of the invention, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### APPENDIX A

### Boundary Detection Algorithm, in C++ Programming Language

int Width=100, Height=100;
int Background, Data, Marked, Edge;
short int imageBuffer[Width][Height];
void flood(int x, int y)
{

int head, tail,i;

//if the current pixel is Marked or Edge escape out of routine

if (ImageBuffer[x][y]==Marked) return;
if (ImageBuffer[x][y]=Edge) return;

//if the current pixel is Data, mark it as Edge and return

if (ImageBuffer[x][y]=Data){

ImageBuffer[x][y]=Edge;

return;

}

//find left edge of screen or data on left side

head=x;
while ((ImageBuffer[head][y] ==Background) && (head > 0)){

head--;

}
if(ImageBuffer[head][y]==Data){

ImageBuffer[head][y]=Edge;

}
if(head) head++;

//find right edge of screen or data on left side

tail=x;
while ((ImageBuffer[tail][y]==Background) && (tail < (Width−1))){

tail++;

}
if(ImageBuffer[tail][y]==Data){

ImageBuffer[tail][y]=Edge;

}
tail--;
if(head>tail) {

head=x;
tail=x;

}

//set from head to tail to Marked

for(i=head;i!=(tail+1);i++) ImageBuffer[i][y]=Marked;

//look for open pixels above

if(y>0) {

for(i=head;i!=(tail+1);i++) flood(i,y−1);

}

//look for open pixels below

if(y<Height) {

for(i=head;i!=(tail+1);i++) flood(i,y+1);

}

}
int main( ) {

int x, y;
unsigned char ch;
int loop,z;

//read image into ImageBuffer

ReadImageIntoImageBuffer( );

//change every pixel to either Background or Data

for(y=0;y!=Height;y++) {

for(x=0;x!=Width;x++) {

ch=ImageBuffer[x][y];

if((x==0) && (y==0)) {

Background=ch;
Data=(Background+20) & Oxff;
Marked=(Background + 40) & Oxff;
Edge=(Background + 70) & Oxff;

}
if (!(ch==Background)) ch=Data;

ImageBuffer[x][y]=ch;

}

}

//ok, now we're ready to do the flood fill

flood(1,1);

//go to only background and edges

for(y=0;y!=Height;y++) {

for(x=0;x!=Width;x++) {

if(ImageBuffer[x][y]!=Edge)-
ImageBuffer[x][y]=Background;

}

}

return 0;

}

1. A method for setting a location of an incising boundary around at least one object, comprising:
determining a perimeter edge of each object around which said incising boundary is to be formed; and
assigning a location of said incising boundary in relation to said perimeter edge of said each object.

2. The method of claim 1, wherein said assigning includes:
forming a series of stepped outlines around said perimeter edge of each object;
determining a perimeter distance for each of said series of outlines;
determining a difference in said perimeter distance of adjacent outlines; and
selecting as said incising boundary one outline of an adjacent pair of outlines based on a comparison of said difference with a predetermined threshold.

3. The method of claim 2, wherein each stepped outline is formed using a snug fit algorithm to determine a perimeter, and then marking a number of adjacent pixels to said perimeter to establish a step size of said each stepped outline.

4. The method of claim 2, wherein said selecting begins at an outermost outline and progresses inward toward said perimeter edge of said each object.

5. The method of claim 2, wherein said perimeter distance is in units of perforations per inch (PPI), and wherein said predetermined threshold is about the PPI divided by 2.

6. The method of claim 2, wherein if none of said difference in said perimeter distance of adjacent outlines is greater than a threshold, then the method further comprising selecting as said incising boundary said perimeter edge of said each object.

7. The method of claim 2, wherein said series of stepped outlines includes at least three outlines.

8. The method of claim 2, wherein said series of stepped outlines is a predetermined number of outlines.

9. The method of claim 1, wherein said assigning includes:
identifying an object as having a perimeter defining at least one perimetrical cove;
forming a series of stepped outlines around said object having said at least one perimetrical cove; and
selecting for the location of said incising boundary one outline of said series of stepped outlines that bridges said at least one perimetrical cove.

10. The method of claim 9, further comprising:
determining a perimeter distance for each of said series of outlines; and
said selecting includes identifying an outline from said series of stepped outlines that has a smaller perimeter distance than said perimeter distance of a previous outline.

11. The method of claim 9, further comprising:
determining a perimeter distance for each of said series of outlines; and
said selecting includes:
determining a difference in said perimeter distance of adjacent outlines; and
identifying from said series of stepped outlines an outline that has a smaller perimeter distance than said perimeter distance of a previous outline and said outline selected is a last outline wherein said difference is greater than a predetermined threshold.

12. The method of claim 11, wherein said perimeter distance is in units of perforations per inch (PPI), and wherein said threshold is about the PPI divided by two.

13. The method of claim 9, wherein said selecting begins at an innermost outline with respect to said perimeter edge of said object and progresses outward toward an outermost outline.

14. The method of claim 1, further comprising performing an incising operation at said incising boundary.

15. The method of claim 14, wherein said incising operation is one of a perforation operation and a cutting operation.

16. The method of claim 1, wherein said at least one object is a plurality of objects and said incising boundary is selected when all individual outlines around each of said plurality of objects merge into a single outline using a snug fit algorithm.

17. The method of claim 1, wherein said assigning includes:
identifying a perimeter of an object;
expanding said perimeter outwardly by applying a plurality of successive stepped outlines;
determining a perimeter of an outermost outline of said plurality of successive stepped outlines; and
contracting said perimeter inwardly by applying a plurality of successive stepped reductions.

18. The method of claim 17, wherein each outline of said plurality of successive stepped outlines is formed using a snug fit algorithm.

19. The method of claim 17, wherein each stepped reduction of said plurality of successive stepped reductions is performed using a snug fit algorithm.

20. The method of claim 17, wherein said incising boundary is located on an innermost outline of said plurality of successive stepped reductions.

21. The method of claim 17, wherein said object has at least one cove, and wherein an outermost outline of said plurality of successive stepped outlines substantially bridges over each of said at least one cove.

22. The method of claim 21, wherein an outline of an innermost stepped reduction of said plurality of successive stepped reductions has substantially the same shape as said outermost outline of said plurality of successive stepped outlines.

23. The method of claim 17, wherein a quantity of said plurality of successive stepped outlines is greater than three.

24. The method of claim 17, wherein a quantity of said plurality of successive stepped outlines is based on a perforation density of an incising operation to be performed at said incising boundary.

25. The method of claim 17, wherein a quantity of said plurality of successive stepped reductions used in said contracting is equal to a quantity of said plurality of successive stepped outlines used in said expanding.

26. A method for setting a location of an incising boundary around at least one object, comprising:
forming a series of stepped outlines around said at least one object; and
selecting one outline of said series of stepped outlines for locating said incising boundary.

27. A method for setting a location of an incising boundary around an object, comprising:
identifying a perimeter of said object;
expanding said perimeter outwardly by applying a plurality of successive stepped outlines;
determining a perimeter of an outermost outline of said plurality of successive stepped outlines;
contracting said perimeter of said outermost outline inwardly by applying a plurality of successive stepped reductions; and
locating an incising boundary in relation to an innermost outline formed at the last of said plurality of successive stepped reductions.
